(19) United States
(12) Patent Application Publication
(10) Pub. No.: US 2012/0048805 A1
(43) Pub. Date: Mar. 1, 2012

(54) METHOD OF MODIFYING THIN FILM COMPOSITE MEMBRANE SUPPORT STRUCTURES FOR ENGINEERED OSMOSIS APPLICATIONS

(75) Inventors: Jeffrey McCutcheon, Coventry, CT (US); Jason Arena, New Britain, CT (US); Benny Freeman, Austin, TX (US); Bryan McCloskey, Campbell, CA (US)

(73) Assignees: University of Texas at Austin, Austin, TX (US); UNIVERSITY OF CONNECTICUT, Farmington, CT (US)

(21) Appl. No.: 13/184,987

(22) Filed: Jul. 18, 2011

Related U.S. Application Data
(60) Provisional application No. 61/399,754, filed on Jul. 16, 2010.

(51) Int. Cl. B01D 71/28; B01D 61/02; B01D 67/00; B01D 61/00

(52) U.S. Cl. 210/654; 210/483; 427/244

(57) ABSTRACT

The disclosure provides a method of modifying thin film composite membrane support structures. In particular, the disclosure provides method of modifying thin film composite membrane support structures with poly(dopamine) for use with engineered osmosis applications.

### BACKGROUND OF THE INVENTION

1. Field of the Invention

This disclosure relates to methods of producing membranes. In particular, the disclosure provides methods of producing membranes for use with engineered osmosis applications.

2. Description of Related Art

Conventional thin film composite membranes have a highly anisotropic structure which provides both high permeability and selectivity in pressure-driven membrane separations like reverse osmosis (RO), nanofiltration (NF), and ultrafiltration (UF). The chemical properties necessary for a suitable support layer to produce these asymmetric structures are detrimental due to unique mass transfer limitations in osmotic flow.

Osmotic flow refers to flow through a membrane which is induced by concentration gradients across a membrane's selective layer. For osmotic flow to occur it is necessary that the membrane have sufficient selectivity to separate the concentration gradient inducing particles and prevent them from crossing-through the membrane.

Commonly the induced driving force for osmotic flow from concentration gradients is described as the osmotic pressure. This is a pressure exerted by the presence of solutes in solution and/or particles in a mixture/suspension. The solvent, water, is pulled from a lower solute/particle (and correspondingly higher solvent) concentration feed solution to a higher solute/particle (and correspondingly lower solvent) concentration draw solution.

A unique mass transfer limitation exists with osmotic flow processes, described as internal concentration polarization. This occurs within the support layer pore structure of a membrane (when osmotic flow occurs) where solutes have to diffuse towards or away from the membrane support layer for efficient (highest possible flux from the lowest bulk osmotic agent concentration) osmosis to occur. The amount and direction of this solute diffusion depends on the membrane orientation relative to the direction of osmosis.

In osmotic flow, where the membrane's selective layer is in contact with the draw solution (described as the pressure retarded osmosis or PRO mode/orientation), solutes which pass through the membrane selective layer must diffuse through the porous polymer mid-layer to enter into the feed solution. If the solutes are unable to diffuse through the mid-layer they will become entrained within the membrane's support, and unable to diffuse into the bulk feed solution reduce the effective osmotic pressure across the membrane selective layer.

In osmotic flow, where the membrane's support layers are in contact with the draw solution (described as the forward osmosis or FO mode/orientation), solutes must first diffuse through the membrane support layers before reaching the selective layer where osmosis can occur. Typically diffusion of the osmotic agent occurs slower than water flux which results in a dilution of the osmotic agent at the membrane interface reducing the osmotic pressure driving force through the membrane selective layer.

Current generation thin film composite (TFC) membranes are fabricated using a multi-tiered structure comprised of an exceedingly fragile selective layer supported by one or more porous support layers. In a typical reverse osmosis membrane, the selective layer is a polyamide that is deposited through a polycondensation reaction. This carefully controlled reaction is impacted by the type of support used. These support layers are typically hydrophobic due to the delicate polymerization method required to deposit the thin selective layer. The hydrophobic nature of these supports helps create the selective layer with the appropriate properties, being the membrane's selectivity and permeability.

The hydrophobic support layers inhibit osmotic flow across the selective layer due to incomplete wetting of this porous layer. This incomplete wetting reduces the transport of solutes through a membrane's support layers, resulting in a lower osmotic pressure difference across the membrane's selective layer. This lower osmotic pressure reduces the amounts of water that goes from the feed to the draw solution.

### SUMMARY OF THE INVENTION

In a broad aspect, the disclosure encompasses a method of modifying thin film composite membrane support structures for engineered osmosis applications.

Thus, one aspect of the disclosure provides a method of modifying a thin film composite membrane, wherein the thin film composite membrane comprises a selective layer and a support layer, the method comprising:

wetting the support layer with a wetting agent to produce a wetted layer;

rinsing the wetted layer to produce a rinsed layer; and

coating the rinsed layer with poly(dopamine).

The disclosure also provides a modified thin film membrane prepared according to a method as described above. Thus, in one aspect the disclosure provides a modified thin film membrane structure comprising:

a selective layer; and
a support layer comprising:
   a porous polymer layer,
   a fabric layer, or
   a combination thereof,
      wherein the support layer is coated with poly(dopamine).

The disclosure further provides use of a modified thin film membrane structure of the disclosure in engineered osmosis applications.

### DESCRIPTION OF DRAWINGS

The present disclosure may be better understood and its numerous objects and advantages will become apparent to those skilled in the art by reference to the accompanying drawings in which:

FIG. 1 is a flow diagram of a method of modifying the support layer of thin film composite membrane support structures.

FIG. 2 is a flow diagram of another method of modifying the support layer of thin film composite membrane support structures.

FIG. 3 illustrates the improvement in the hydrophilicity of poly(dopamine) modified membranes.

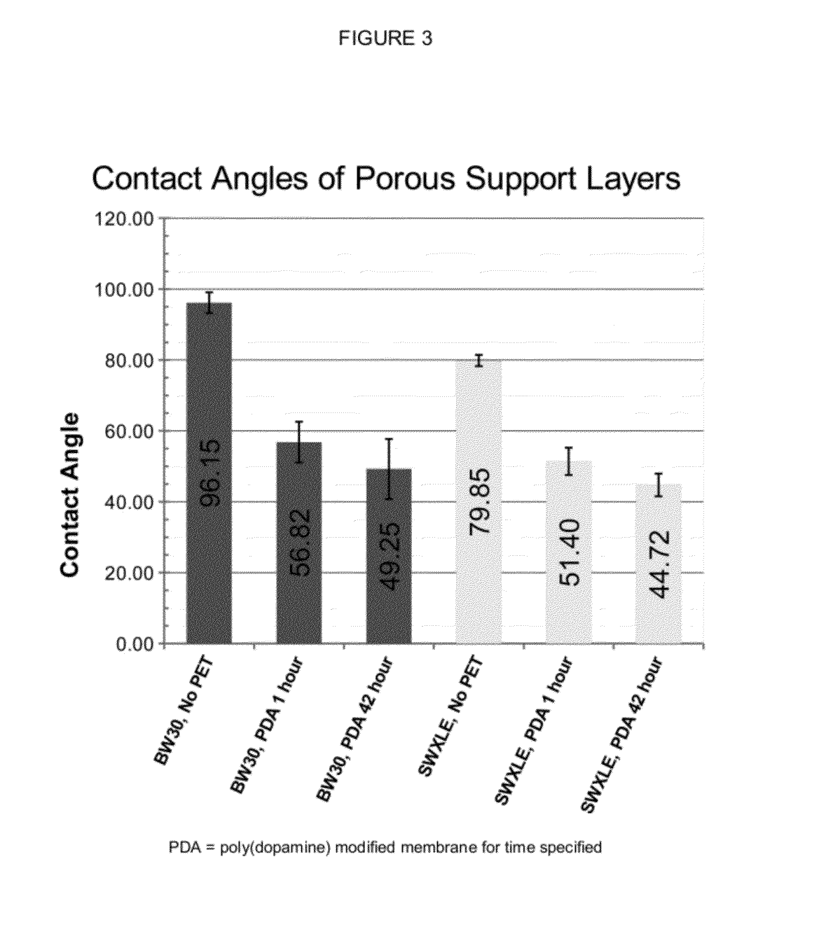

FIG. 4 illustrates the osmotic flux performance of a seawater RO membrane as is (neat), with no fabric layer (No PET), modified with poly(dopamine) for 1 hour and modified with poly(dopamine) for 42 hours. The draw solution is in contact with the membrane selective layer (PRO mode).

FIG. 5 illustrates the osmotic flux performance of a brackish water RO membrane as is (neat), with no fabric layer (No PET), modified with poly(dopamine) for 1 hour and modified with poly(dopamine) for 42 hours. The draw solution is in contact with the membrane selective layer (PRO mode).

FIG. 6 illustrates the osmotic flux performance of a seawater water RO membrane as is (neat), with no fabric layer (No PET), modified with poly(dopamine) for 1 hour and modified with poly(dopamine) for 42 hours. The draw solution is in contact with the membrane support layer (FO) mode).

FIG. 7 illustrates the osmotic flux performance of a brackish water RO membrane as is (neat), with no fabric layer (No PET), modified with poly(dopamine) for 1 hour and modified with poly(dopamine) for 42 hours. The draw solution is in contact with the membrane support layer (FO mode).

FIG. 8 shows the increase in hydraulic permeability across BW30 TFC membrane treated in accordance with the disclosure.

FIG. 9 shows the decrease in hydraulic permeability across SWXLE TFC membrane treated in accordance with the disclosure.

FIG. 10 illustrates a negligible change in the salt rejecting properties after poly(dopamine) modification of BW30 TFC membrane treated in accordance with the disclosure.

FIG. 11 shows a negligible change in the salt rejecting properties after poly(dopamine) modification of SWXLE TFC membrane treated in accordance with the disclosure.

FIG. 12 shows the contribution of ranges of pore diameter to the overall porosity of BW30 TFC membrane with the PET fabric backing removed.

FIG. 13 illustrates the contribution of ranges of pore diameter to the overall porosity of SWXLE TFC membrane with the PET fabric backing removed.

FIG. 14 illustrates the pore structures of a thin film composite membrane support structure coated with poly(dopamine) and a thin film composite membrane support structure that is not coated with poly(dopamine).

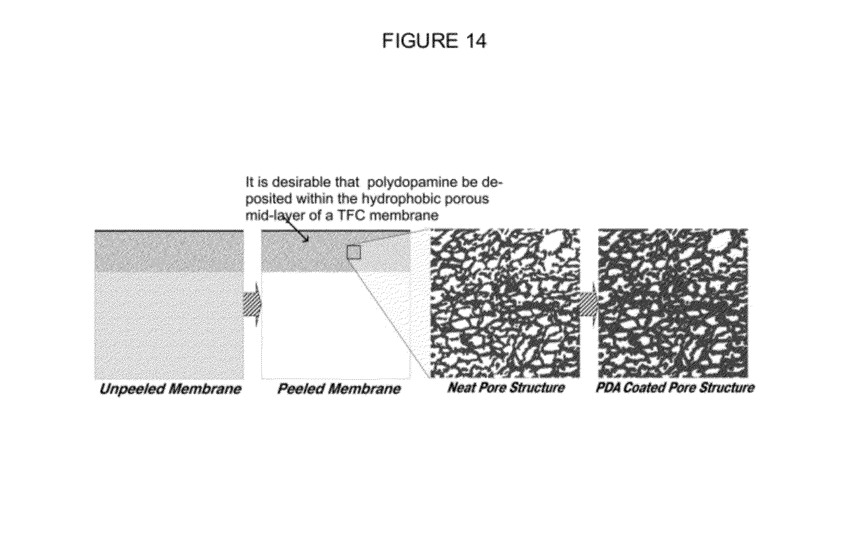

### DETAILED DESCRIPTION OF THE INVENTION

All embodiments of any aspect of the invention can be used in combination, unless the context clearly dictates otherwise.

As used herein, the singular forms “a”, “an” and “the” include plural referents unless the context clearly dictates otherwise. “And” as used herein is interchangeably used with “or” unless expressly stated otherwise.

In most membrane development methods, the support layer simply acts to provide mechanical strength to the selective layer. It plays no role in selectivity or productivity. In engineered osmosis applications, however, the support layer inhibits the mass transport of solutes in solution. The lack of wetting of this layer has been shown to negatively impact flux performance across TFC and asymmetric membranes during osmotic flow.

The method of the disclosure offers a way to selectively hydrophilize (improve the hydrophilic character of a material) the membrane support layer with poly(dopamine). In the present disclosure, the hydrophilization (e.g., coating) of the support layer with poly(dopamine) increases the transport of solutes through membranes' support layers, resulting in higher flux performance across the membrane's selective layer (e.g., increased osmotic flow across the selective layer) and diminished concentration polarization effects. For example, the membranes modified according to the method of the invention exhibited at least 10-times higher flux performance compared to the unmodified membranes.

Thus, in one embodiment, the disclosure provides a method of modifying a thin film composite membrane, wherein the thin film composite membrane comprises a selective layer and a support layer, the method comprising:

wetting the support layer with a wetting agent to produce a wetted layer;

rinsing the wetted layer to produce a rinsed layer; and

coating the rinsed layer with poly(dopamine).

This method can be implemented easily into existing membrane manufacturing systems or applied to assembled modules.

Conventional TFC membranes begin with a non-woven fabric support layer upon which is cast a polymer solution of a hydrophobic polymer that is precipitated by submerging the cast-film and support in a non-solvent. This forms a porous structure that is the substrate for the delicate polymerization process that creates a very thin film. The qualities of this film dictate the ability of the membrane to prevent various particles from passing through it. The polymer support layers are typically hydrophobic due to the polymerization method utilized to deposit the thin selective layer. The hydrophobic nature of these supports helps create the selective layer with the appropriate properties; however, after formation of the selective layer, the hydrophobic support layers inhibit osmotic flow across the selective layer due to incomplete wetting of this porous layer.

Such membranes include all thin film composite and asymmetric membranes that are capable of rejecting salt. Non-limiting examples include Dow BW30, SW30-XLE (SWXLE), and SW30-HR, the Hydration Technology Innovations 080118, 090128 100525, the Koch TFC-HR and TFC-XR, and the General Electric AD HR, AE HR, AG HR, AK HR membranes.

In one embodiment, the disclosure also provides a method as described above, where the support layer typically comprises a composite structure consisting of some high mechanical strength fabric support and a porous polymer layer. The manufacture this porous polymer layer is made by depositing and drawing a polymer solution onto/over the fabric layer. The solution is submerged in a water bath giving rise to a porous structure made of the polymers within the polymer solution.

In one embodiment, the disclosure provides a method as described above where the support has had all or part of the fabric support layer removed.

In one embodiment, the disclosure provides a method as described above where the support layer structure omits the fabric layer and the deposition, drawing and submersion of the polymer solution is done onto a nonporous structure as the fabric support does not contribute to the final properties of the membrane.

In one embodiment, the disclosure provides a method as described above where the support layer structure is a highly porous nonwoven mat produce through the drawing of a polymer solution over a large voltage potential to create a porous fibrous mat (electrospinning). This technique may be used to produce a porous polymer support layer or spun onto a fabric support layer or both.

In one embodiment, the disclosure provides a method as described above where the support layer is a porous hollow fiber and the complete membrane structure is encapsulated within that fiber.

In one embodiment, the disclosure provides a method as described above, where the support layer comprises a porous polymer layer, a fabric layer, or a combination thereof.

In one embodiment, the disclosure provides a method as described above, wherein the support layer comprises a porous polymer layer and a fabric layer. In another embodiment the support layer comprises a porous polymer layer and a fabric support layer, wherein the porous polymer layer is disposed between the selective layer and the fabric layer (e.g., a porous polymer mid-layer). In another embodiment, the support layer comprises only a porous polymer layer without a fabric layer. Preferably, the porous polymer layer of the disclosure is hydrophobic.

In one embodiment where the support layer comprises a fabric layer and a porous polymer payer, the disclosure provides a method as described above, further comprising removing the fabric layer prior to wetting the porous polymer layer to produce the wetted layer.

The disclosure provides a method as described above, wherein wetting comprises wetting the porous polymer layer to produce the wetted layer.

The disclosure also provides a method as described above, wherein wetting comprises wetting the porous polymer mid-layer and a fabric support layer to produce the wetted layer.

The disclosure also provides a method as described above, wherein the wetting agent is an alcohol, surfactant, or the like. In one embodiment, the wetting agent is alcohol. The alcohol is preferably lower alcohol (e.g., methanol, ethanol, isopropyl alcohol, etc.) In one embodiment, the wetting agent is isopropyl alcohol. In another embodiment, the wetting agent is a surfactant. Non limiting examples of surfactants include, sodium dodecyl sulfate (SDS) and Galwick.

The disclosure also provides a method, as described above, wherein the wetting step is omitted. In this embodiment, the porous polymer support layer is not dried out as part of the fabrication process. In another embodiment, the porous polymer support layer is naturally wet out.

In one embodiment, the disclosure provides a method as described above, wherein rinsing comprises rinsing with water to remove the wetting agent. In one embodiment, rinsing comprises rinsing with water to remove remnants of fabrication. For example, the water may comprise a deionized water bath. In one embodiment, the deionized water bath is chilled.

Rinsing with water to remove the wetting agent is done at least once. In one embodiment, rinsing is performed three or more (3, 4, 5, 6, 7, 8, 9, 10, etc.) times. The rinsing can be carried out for any suitable length of time and under any suitable conditions. In one embodiment, rinsing is performed three times for approximately 45 minutes.

In one embodiment, the disclosure provides a method as described above, further comprising storing the rinsed layer in chilled deionized water prior to coating. Chilled water has temperature of less than 10° C.; preferably less than 7° C. (e.g., between 4° C. and 7° C.). In some embodiments, chilled water has temperature about 0° C. or less.

The disclosure provides a method as described above, coating the rinsed layer with poly(dopamine) comprises exposing only the rinsed layer (the support layer) to the poly(dopamine).

In another embodiment of the disclosure, coating the rinsed layer with poly(dopamine) comprises exposing the rinsed layer (the support layer) and the selective layer to the poly(dopamine).

In the methods described above, poly(dopamine) is used to coat the support layer. Coating by poly(dopamine) occurs as a layer-by-layer polymerization of onto surfaces of nearly any material exposed to the coating solution. Poly(dopamine) is obtained by mixing dopamine solution with a buffer solution at basic pH. The buffer may comprise any suitable pH and other components. Suitable buffers include, but are not limited to, tris(hydroxymethyl)aminomethane (TRIS) buffer, sodium bicarbonate buffer, sodium phosphate buffer, 3-{[tris(hydroxymethyl)methyl]amino}propanesulfonic acid (TAPS), N,N-bis(2-hydroxyethyl)glycine (Bicine), N-tris(hydroxymethyl)methylglycine (Tricine), 3-[N-Tris(hydroxymethyl)methylamino]-2-hydroxypropanesulfonic Acid (TAPSO), 4-2-hydroxyethyl-1-piperazineethanesulfonic acid (HEPES), 2-{[tris(hydroxymethyl)methyl]amino}ethanesulfonic acid (TES), 3-(N-morpholino)propanesulfonic acid (MOPS), N-(1,1-Dimethyl-2-hydroxyethyl)-3-amino-2-hydroxypropanesulfonic acid (AMPSO), 2-(Cyclohexylamino)ethanesulfonic acid (CHES), 3-(Cyclohexylamino)-2-hydroxy-1-propanesulfonic acid (CAPSO), β-Aminoisobutyl alcohol (AMP-100, AMP-90, AMP-75, AMP), 3-(Cyclohexylamino)-1-propanesulfonic acid (CAPS), 4-(Cyclohexylamino)-1-butanesulfonic acid (CABS), and the like. In one embodiment, poly(dopamine) is obtained by mixing dopamine solution with Tris-HCl buffer solution. The buffer solution (e.g., Tris-HCl buffer solution) has a pH of about 7.5 to 14; in one embodiment, 7.5 to 12; and in another embodiment, 8 to 10. In one embodiment, the buffer solution has a pH of about 8.5 to about 8.7.Tris-Hydrochloride buffer solution. In one embodiment, this Tris-Hydrochloride buffer solution is pH about 8.5 to about 8.7. The pH facilitates polymerization by causing dopamine to reorder itself, thereby allowing for oxidative self-polymerization to occur. Poly(dopamine) has been used to coat the selective layer of thin film composite and asymmetric membranes to reduce fouling. The poly(dopamine) increases the selective layer hydrophilicity, which inhibits deposition of fouling agents. It should be appreciated that poly(dopamine) is not used to coat the selective layer of thin film composite and asymmetric membranes in the method of disclosure.

Coating the rinsed layer with poly(dopamine) can be done at any suitable temperature. In one embodiment, the coating is done at room temperature in a method as described above. Such room temperatures are between about 20° and about 25° C. In another embodiment, coating the rinsed layer is done below room temperature. For example, between about 0° and about 20° C. In yet another embodiment, coating the rinsed layer is done above room temperature, e.g., above about 25° C. In one embodiment, coating is done between about 30° to about 50° C.

The coating step may be carried out for any suitable length of time. In one embodiment, the coating step is carried out for at least between about 10 minutes and about 48 hours. The rinsed layer is coated with poly(dopamine) for up to 48 hours. In another embodiment, the rinsed layer is coated with poly(dopamine) for about 1 hour to about 48 hours. In another embodiment, the rinsed layer is coated with poly(dopamine) for about 24 hours to about 48 hours. In yet another embodiment, the rinsed layer is coated with poly(dopamine) for at least about 48 hours, or for about 48 hours.

In one embodiment of the method as described above, the selective layer is coated with poly(dopamine) in addition to the support layer. For example, in one disclosure of the invention, each layer of the thin film composite membrane is coated with poly(dopamine).

In a method as described above, the steps of wetting, rinsing and coating are conducted during manufacturing of the thin film composite membrane. This is ideally done following the synthesis of the selective so that the increase hydrophilicity of the support layer does not alter the properties of the selective layer.

The disclosure also provides a method as described above, wherein the steps of wetting, rinsing and coating are conducted after the step of manufacturing of the thin film composite membrane, including but not limited to the modification of a membrane module to selectively coat the support layer (and separately coat the selective layer in embodiments where both layers are coated).

In one embodiment, a method of the disclosure is employed in batch mode, continuous processing (manufacturing line), membrane modification (coating within a membrane structure after membrane fabrication), or module modification (coating within the module after fabrication).

The disclosure also provides a modified thin film membrane prepared according to a method as described above. Such membranes include all thin film composite and asymmetric membranes that are capable of rejecting salt.

In one embodiment, the disclosure provides a modified thin film membrane structure comprising:

a selective layer; and

a support layer comprising:

a porous polymer layer,

a fabric layer, or

a combination thereof, wherein the support layer is coated with poly(dopamine).

Such membranes include all thin film composite and asymmetric membranes as described above.

A modified thin film membrane as described above, the support layer comprises a combination of the porous polymer layer and the fabric layer.

In one embodiment, the porous polymer layer of a modified thin film membrane as described above is disposed between the selective layer and the fabric layer. In another embodiment, the support layer comprises the porous polymer layer only.

In another embodiment, the porous polymer layer is coated with poly(dopamine). In another embodiment, the porous polymer layer and the fabric layer are both coated with poly(dopamine).

In a modified thin film membrane as described above, the selective layer is coated with poly(dopamine) in addition to the support layer. For example, in one disclosure of the invention, each layer of the thin film composite membrane is coated with poly(dopamine).

In a modified thin film membrane as described above, at least 20% of the support layer is coated with poly(dopamine). In one embodiment, at least 40% of the support layer is coated with poly(dopamine), and preferably, at least 50% is coated. In another embodiment, 60% of the support layer is coated with poly(dopamine). In yet another embodiment, at least 80% of the support layer is coated with poly(dopamine). Preferably, at least 90% of the support layer is coated with poly(dopamine); and in one embodiment, 95% is coated. Finally, in one embodiment, at least 99% of the support layer is coated with poly(dopamine).

In a modified thin film membrane as described above, the porous structure of the porous polymer layer is maintained after coating with poly(dopamine). For example, after coating, at least 90% of the pores are maintained in the porous polymer layer. In one embodiment, at least 70% of the pores are maintained in the porous polymer layer, or at least 50% pores are maintained in the porous polymer layer, or at least 20% of the pores are maintained in the porous polymer layer.

In one embodiment, a modified thin film membrane as described above, after the coating step is coated with poly(dopamine) of thickness of about 5 to about 100 nm. In one embodiment, the thickness of poly(dopamine) coat is about 10 to about 80 nm. In another embodiment, the thickness of poly(dopamine) coat is about 20 to about 65 nm. In yet another embodiment, thickness of poly(dopamine) coat is about 30 to about 50 nm.

The modified membranes of the invention mitigate incomplete wetting and internal concentration polarization effects. These membranes show at least a 10- to 20-fold improvement in water flux under osmotic flow testing over the prior compositions and methods. Additionally a substantial reduction in the contact angle was observed in membranes that had been treated with poly(dopamine), indicating the modified membrane support layers of the disclosure have greater hydrophilicity that the unmodified membrane support layers. The modified membranes of the invention show increased the osmotic flow and improved transportation of osmotic agents/solutes across the membrane, and diminished internal concentration polarization effects.

A modified thin film membrane structure of the disclosure can be used in engineered osmosis. In one embodiment, engineered osmosis is forward osmosis, pressure retarded osmosis, direct osmotic concentration, or reverse osmosis.

A modified thin film membrane structure of the disclosure can be used in many membrane water purification applications, such as wastewater treatment, beverage clarification, solution concentration, oil and natural gas produced water treatment, desalination, and power generation.

### DEFINITIONS

The following terms and expressions used herein have the indicated meanings.

The term “contact angle”, as used herein, describes a property relating to the hydrophilicity of a material. A lower contact angle implies greater hydrophilicity.

The term “fabric layer”, as used herein, refers to a layer that acts as a substrate for casting the porous polymer support layer. Such fabric layers provide mechanical support for casting the porous polymer support layer, and usually polyester nonwoven fabric layers. Suitable, non-limiting, examples include PET (polyethylene terephthalate) nonwoven layer, PP (polypropene) nonwoven layer, Rayon nonwoven layer, nylon nonwoven layer, and the like. In one embodiment, the fabric layers are hydrophobic.

The term “membrane” or “actual membrane”, as used herein, refers to the thin interface of the structure which mediates the permeation of all species that come in contact with it.

The term “osmotic agent” is used to describe any chemical species used to generate osmotic pressures in an engineered osmosis system including but not limited to saccharides, polysaccharides, alcohols, nanoparticles (both functionalized and non), ionic chemical species, and mixtures of the aforementioned.

The term “osmotic flow” is used to describe zero (0) pressure difference water flux along an osmotic pressure gradient irrespective of membrane orientation.

The term “peeled”, as used herein, refers to the structure where the fabric layer is removed.

The term “porous polymer layer” or “porous polymer support layer” or “porous polymer mid-layer”, as used herein, refers to the layer of polymer immediately below the selective layer which acts as a mechanical support for the selective layer; also in some applications it serves as the substrate for the synthesis of the selective layer. Ubiquitous in modern thin film composite membranes, this layer imparts little resistance to flow and does not impact selectivity. Suitable, non-limiting, examples include polysulfone (PSu) and polyethersulfone (PES) membrane. Others include polyethylene (PE); polypropylene (PP); polystyrene (PS); polyethylene terephthalate (PET or PETE); polyamide (PA); sulfonated polysulfone or any other polyelectrolyte that is suitable for membrane use; polyester, polyvinyl chloride (PVC); polycarbonate (PC); acrylonitrile butadiene styrene (ABS); polyvinylidene chloride (PVDC); polyacrylonitrile (PAN); polyvinylidene fluoride (PVDF); polytetrafluoroethylene (PTFE); polymethyl methacrylate (PMMA); polylactic acid (PLA); polybenzimidazole (PBI); polypiperazine; cellulose acetate; cellulose triacetate; cellulose butyrate, and combinations thereof. In one embodiment, the selective and support layer are built of the same material. In this embodiment, the selective and support layers may be made of the same material yet fabricated under different conditions and then laminated together.

The term “selective layer”, as used herein, refers to the actual membrane which mediates the permeation of all species through the membrane, imparting the greatest flow resistance (in RO, NF, and UF), and deciding the selectivity of the membrane. Usually, it has the narrowest pore structure (or non-porous) that defines what chemical species are capable of passing through it (i.e., it is the region of the membrane that does not allow ionic and higher molecular weight chemical species from passing through). Such layer can be a polyamide that is deposited through a polycondensation reaction (for reverse osmosis or nanofiltration); polypropylene, poly(vinylidene fluoride), or poly(tetrafluoroethylene) (for microfiltration); or polysulfone, or poly(ether sulfone) (for ultrafiltration), or cellulose acetate, cellulose triacetate, cellulose butyrate, and polybenzimidazole. In addition, the selective layer may include one or more of the following: poly(methyl methacrylate)s, polystyrenes, polycarbonates, polyimides, epoxy resins, cyclic olefin copolymers, cyclic olefin polymers, acrylate or methacrylate polymers, polyethylene terephthalate, polyphenylene vinylene, polyether ether ketone, poly (N-vinylcarbazole), acrylonitrile-styrene copolymer, or polyetherimide poly(phenylenevinylene), sulfonated polysulfones, copolymers of styrene and acrylonitrile, poly(ethylene-co-propylene-co-diene), poly(arylene oxide), polycarbonate, piperazine-containing polymers, polyelectrolytes, styrene-containing copolymers, acrylonitrilestyrene copolymers, styrene-butadiene copolymers, styrene-vinylbenzylhalide copolymers, cellulosic polymers, cellulose acetate-butyrate, cellulose propionate, ethyl cellulose, methyl cellulose, nitrocellulose, polyimides, aryl polyamides, aryl polyimides, polyethers, poly(arylene oxides), poly(phenylene oxide), poly(xylene oxide), poly(esteramide-diisocyanate), polyurethanes, polyesters (including polyarylates), poly(alkyl methacrylates), poly(acrylates), poly(phenylene terephthalate), polysulfides, poly(ethylene), poly(propylene), poly(butene-1), poly(4-methyl pentene-1), polyvinyls, poly(vinyl chloride), poly(vinyl fluoride), poly(vinylidene chloride), poly(vinyl alcohol), poly(vinyl esters), poly(vinyl acetate), poly(vinyl propionate), poly(vinyl pyridines), poly(vinyl pyrrolidones), poly(vinyl ethers), poly(vinyl ketones), poly(vinyl aldehydes), poly(vinyl formal), poly(vinyl butyral), poly(vinyl amides), poly(vinyl amines), poly(vinyl urethanes), poly(vinyl ureas), poly(vinyl phosphates), poly(vinyl sulfates), polyallyls; poly(benzobenzimidazole), polyhydrazides, polyoxadiazoles, polytriazoles, poly (benzimidazole), polycarbodiimides, polyphosphazines and combinations thereof.

The term “support layer”, as used herein, refers to the layer that provides a mechanical support for the selective layer. The support layers are non-selective, and not considered the actual membrane. Typically, the support layers for a thin film composite membrane are hydrophobic, while the support layers of an asymmetric membrane may be hydrophobic or hydrophilic.

The term “water flux” or “flux”, as used herein, refers to the volume of solution (e.g., water, clean water, permeate solution, etc.) flowing through a given membrane area during a given time. Measurement of the amount of water or permeate solution that flows through a membrane.

### EXAMPLES

The preparation of the modified thin film composite membranes of the disclosure is illustrated further by the following examples, which are not to be construed as limiting the disclosure in scope or spirit to the specific procedures and thin film composite membranes described in them.

### Example 1

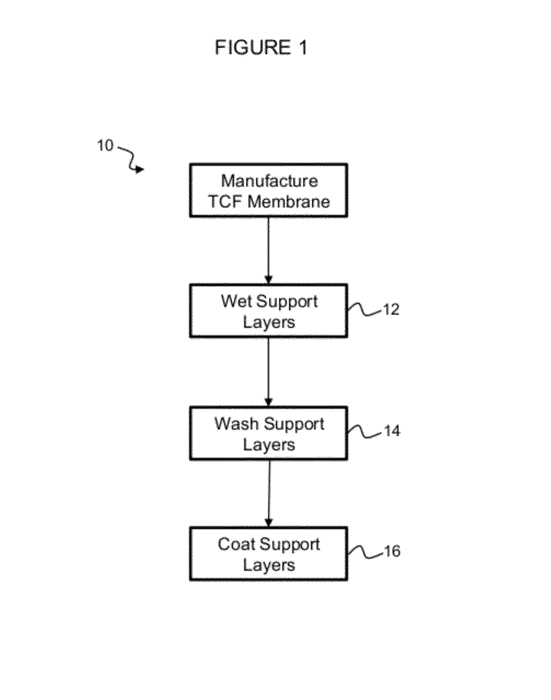

A method of modifying thin film composite membrane support structures (10) is shown in FIG. 1. The membrane support layers are first wetted (12) with isopropyl alcohol (IPA) to allow the poly(dopamine) to coat the inner pores of the membrane. isopropyl alcohol does not negatively affect membrane performance and is easily removed and replaced with water during a subsequent washing step.

Following wetting the support layers, the isopropyl alcohol is rinsed (14) out of the membrane using a series of deionized water baths. The deionized water baths are chilled to prevent the nucleation of air bubbles on the surface and into the pores of the membrane. In the lab scale experiments, the membranes are then stored in chilled deionized water prior to coating.

After the isopropyl alcohol has been removed from the membrane, the support layers are coated with poly(dopamine) (16). The coating step was conducted at room temperature, though alternate temperatures may enhance coating, with only the support layers of the membrane being exposed to the coating solution. The support layers were directly exposed to the poly(dopamine) coating solution, which consisted of two components: 100 mL of a pH 8.7 Tris-Hydrochloride buffer and 2 mL of a 100 gram per liter solution of dopamine. The exposure period to the poly(dopamine) was varied from 1 hour to 42 hours.

This method is applicable to membrane preparation in batch mode, continuous processing, membrane modification, or module modification.

### Example 2

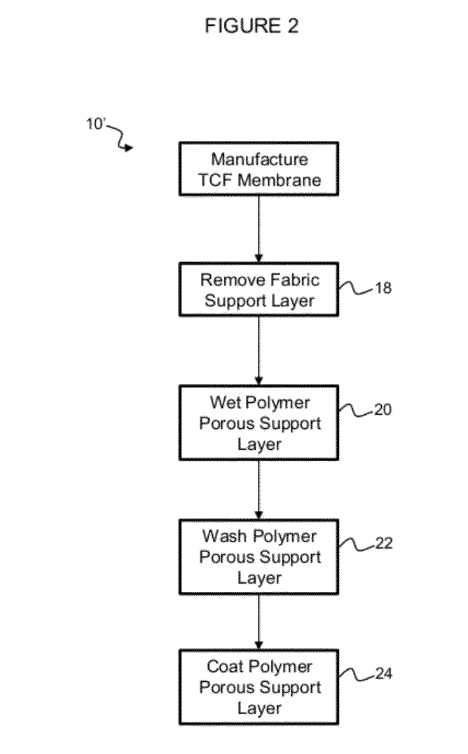

Another method of modifying thin film composite membrane support structures (10) is shown in FIG. 2. The fabric support layer is stripped from the membrane (18). The exposed surface of the polymer porous layer is wetted with isopropyl alcohol (20), rinsed with deionized water (22), and then coated with poly(dopamine) (24). This technique has been used in laboratory experiments with commercial membranes. In particular, Dow Water Process Solutions BW30 and SWXLE membranes were prepared for a PDA coating by wetting out with isopropyl alcohol by soaking it for 1 hour and then rinsed in 3 successive water baths for 45 minutes. They were then coating with PDA for either 1 hour or 42 hours in a special cell which allowed for 2 reservoirs separated by the membrane. The reservoir containing the PDA coating solution was exposed only to the membrane supports layers.

### Example 3: Flux Performance Experiments

The osmotic flux of these membranes was measured in a cross-flow osmosis test system with a draw solution flowrate of 1 LPM (approximately 0.25 m/s), at 23° C., with no pressure differential across the membrane. The osmotic flux was measured with the membrane in both the FO and PRO orientations. The draw solution concentration was changed from 0.05 M to 1.5 M sodium chloride during these experiments. The mass of the draw solution was measure autonomously once every minute and related to a volume change in the solution to determine the water flux.

### Example 4: Water Permeability Experiments

Water permeability was measured by taking the linear regression of data collected in either a lab-scale reverse osmosis system at a flowrate of 0.5 LPM (approximately 0.125 m/s) at 25° C. or in a stirred lab scale dead-end filtration testing unit with the system pressure being adjusted between 150 and 450 psi.

### Example 5: Cross-Flow Salt Rejection Experiments

The salt rejection of these membranes was measured at both 225 and 450 psi in a lab-scale reverse osmosis system at a flowrate of 0.5 LMP (approximately 0.125 m/s) at 25° C. with feed solution being one of 2000 ppm sodium chloride.

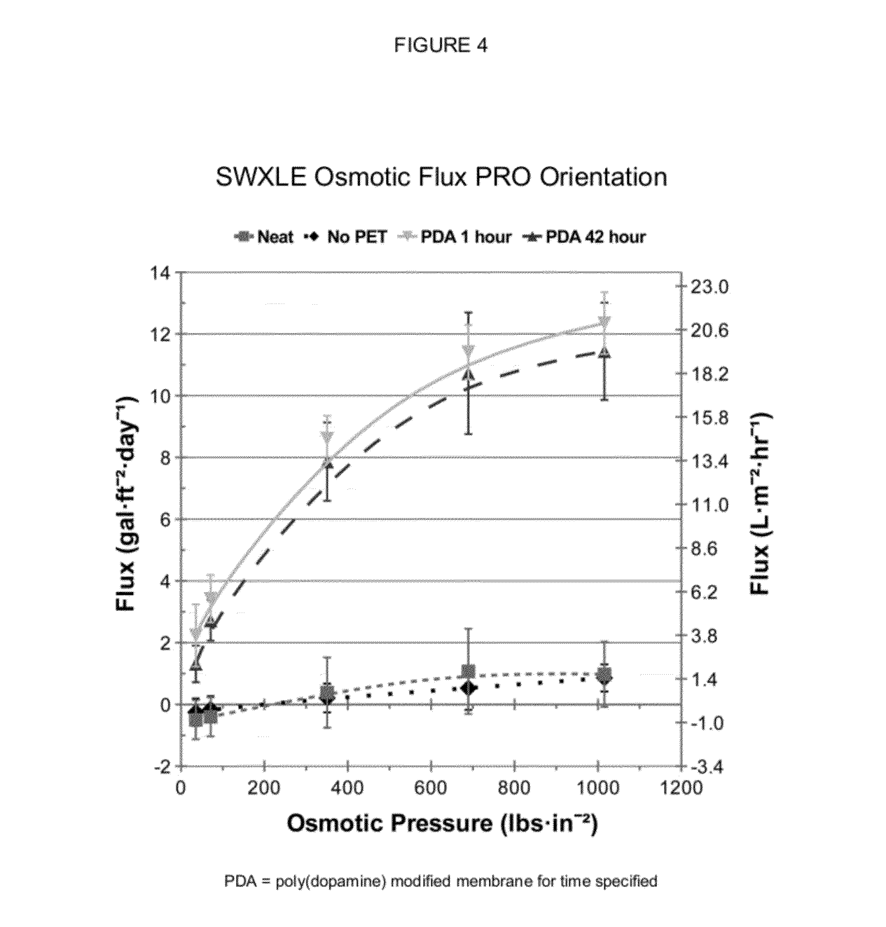

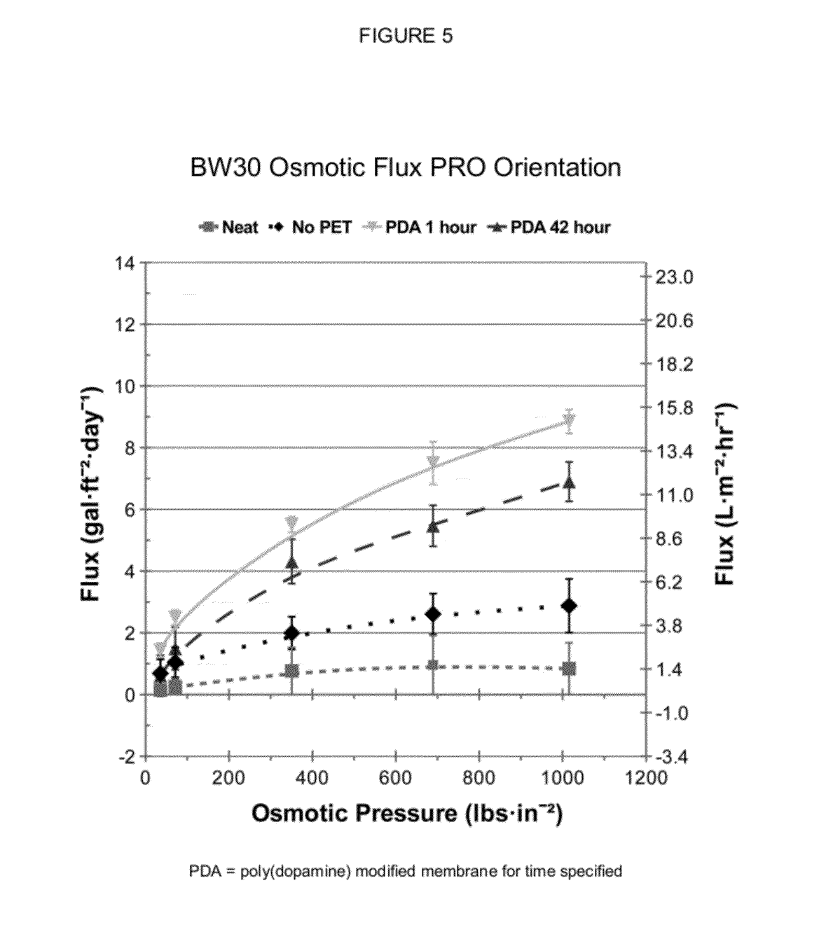

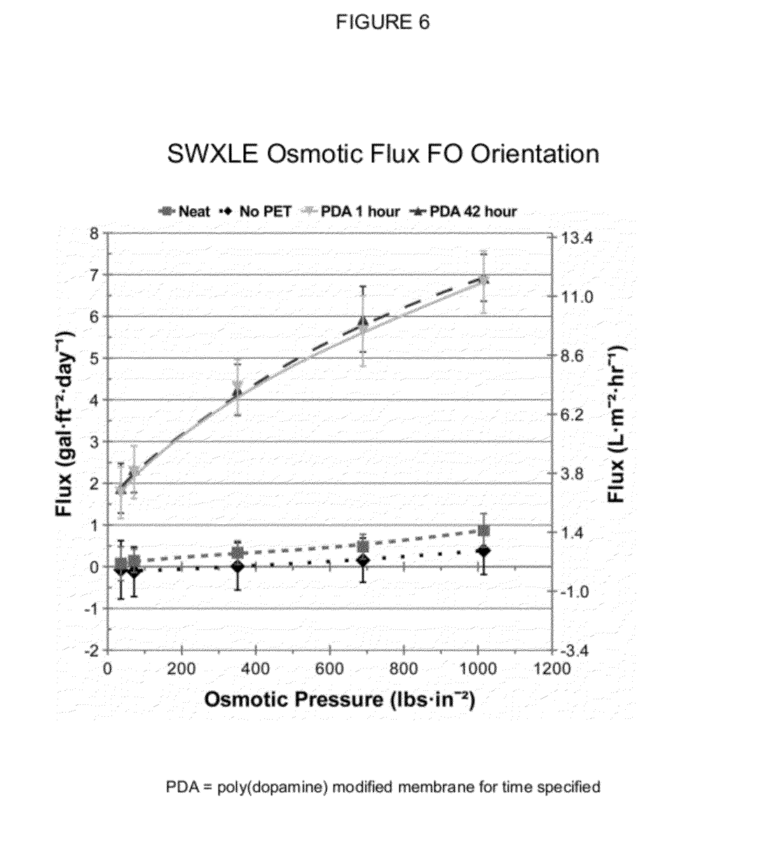

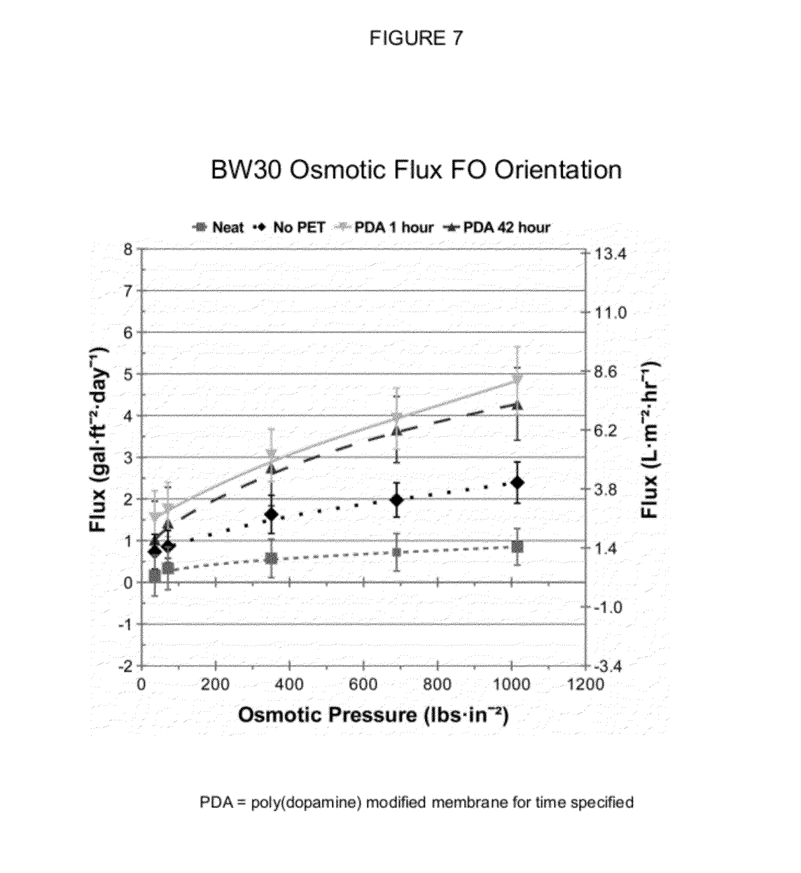

FIGS. 4-7 illustrate the results of testing on commercial reverse osmosis thin film composite membrane supports, Dow Water Process Solutions BW30 and SWXLE membranes. The poly(dopamine) coated membranes (PDA 1 hour BW30; PDA 42 hour BW30; PDA 1 hour SWXLE; PDA 42 hour SWXLE) exhibited up to ten times more flux than unaltered membranes (BW30; No PET BW30; SWXLE; No PET SWXLE). The method is, however, amenable to all asymmetric membrane supports.

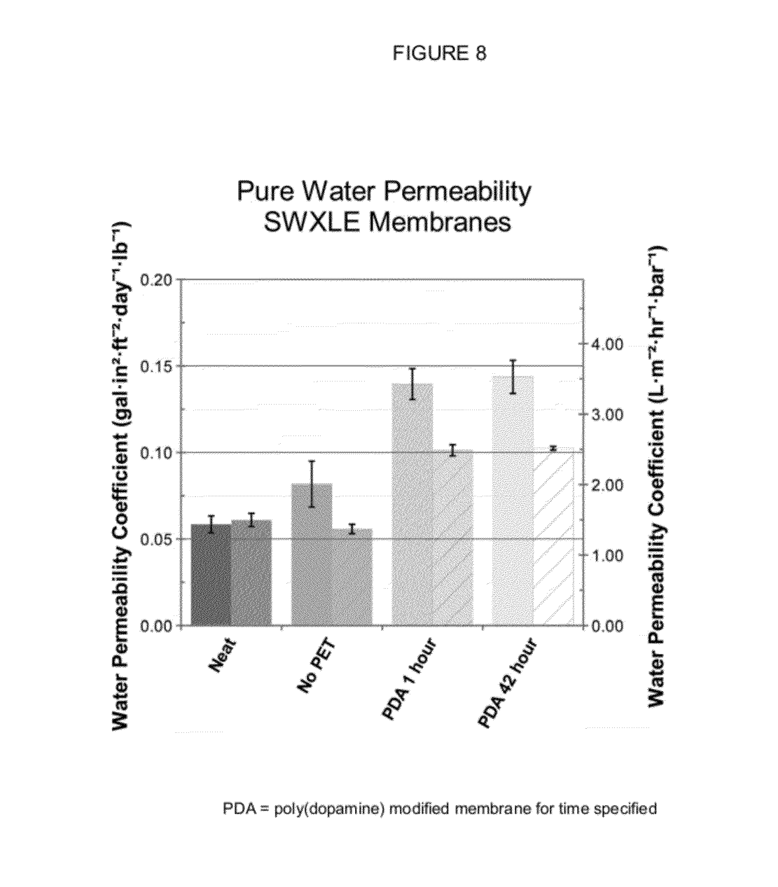

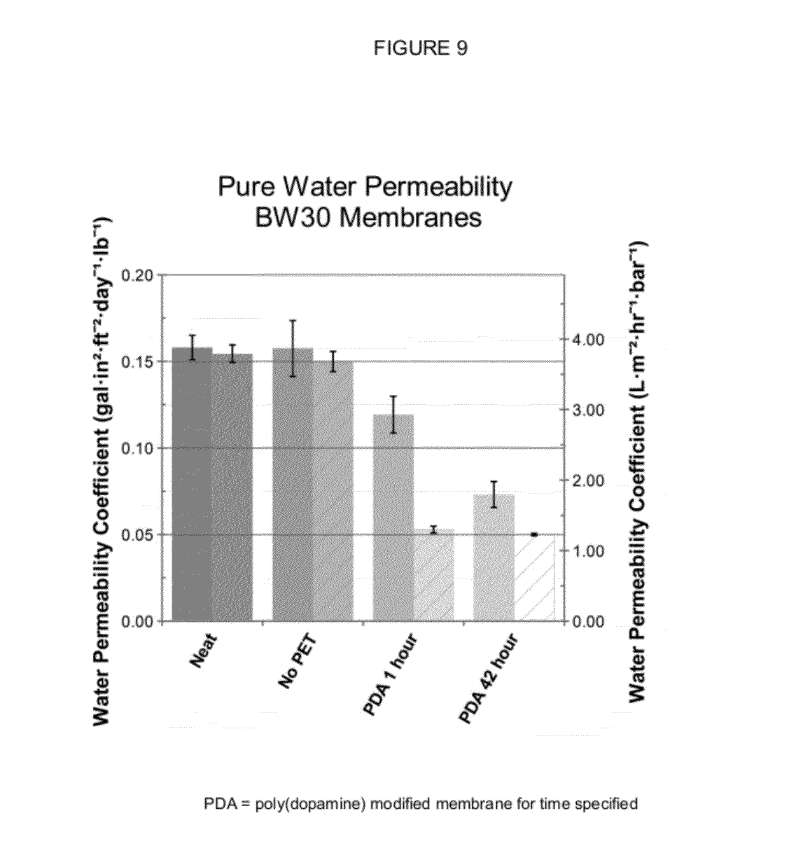

The method of the disclosure has additionally shown an effect on the membrane's hydraulic permeability (FIGS. 8 and 9). This observed effect is contrary to membrane transport phenomena where support layer chemistry is not thought to have an effect on water transport through it.

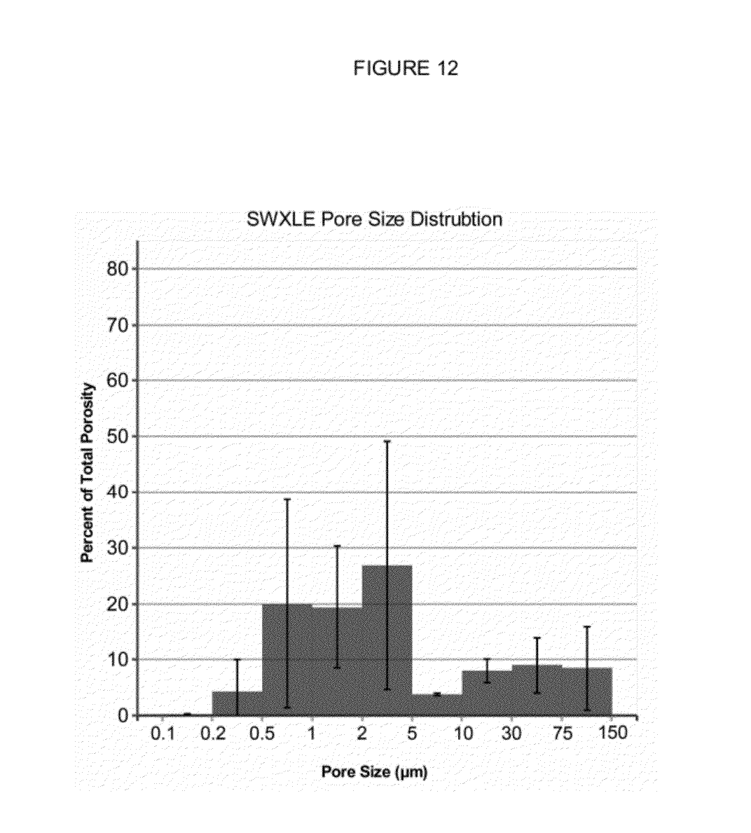

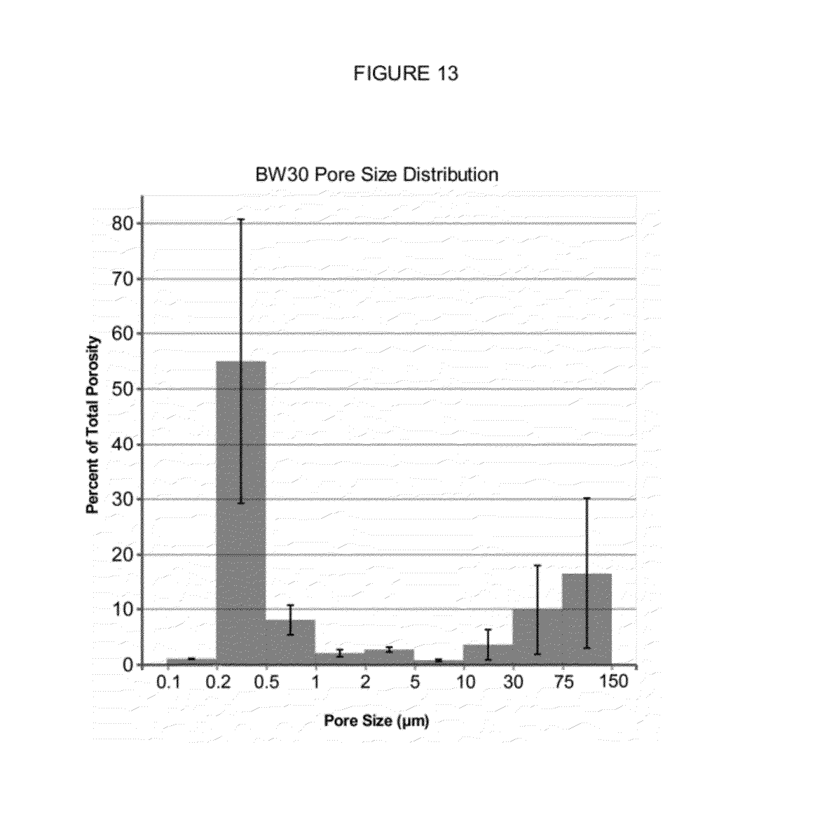

Additionally the improvement in hydraulic permeability occurs with a membrane that has an average larger pore diameter and greater porosity (FIGS. 12 and 13.) The increase in hydraulic permeability expressed itself in experiments with the Dow SWXLE as a doubling of the hydraulic water permeability. This is thought to have occurred as a result of a decrease in the surface energy resistance of very small pores near the selective layer of the membrane, which results in improved partitioning between the membrane's selective layer and porous polymer mid-layer. The resulting reduced hydraulic permeability of the average smaller pore diameter and lower porosity membrane (here the Dow BW30). While a reduction in the hydraulic permeability of this membrane is unusual, it can be explained by the aggregation of poly(dopamine) at pore junctions within the porous polymer mid-layer, resulting is a higher resistance of the membrane to water flow.

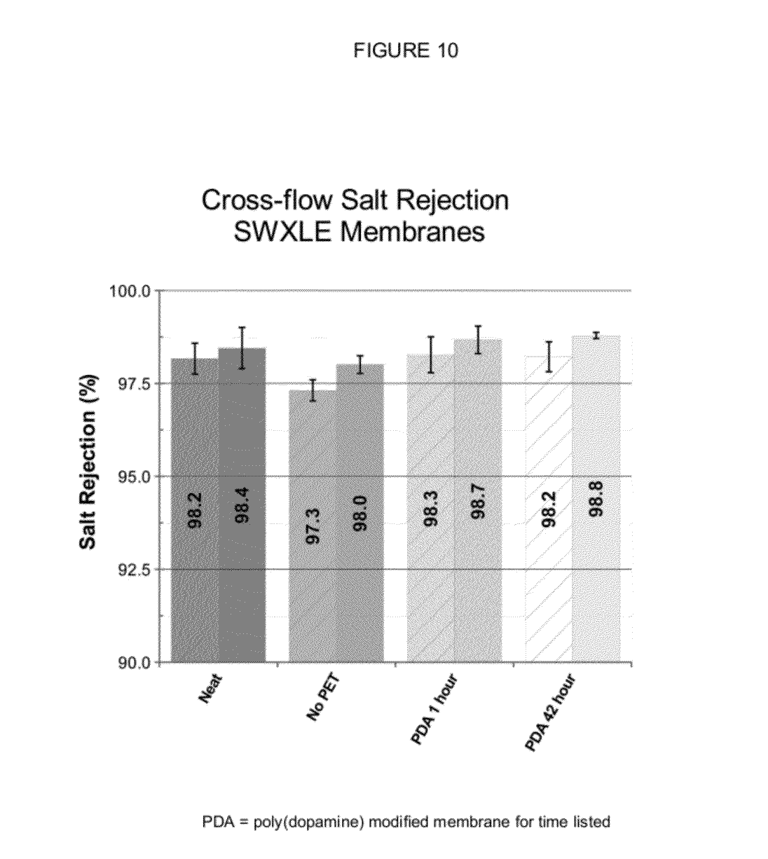

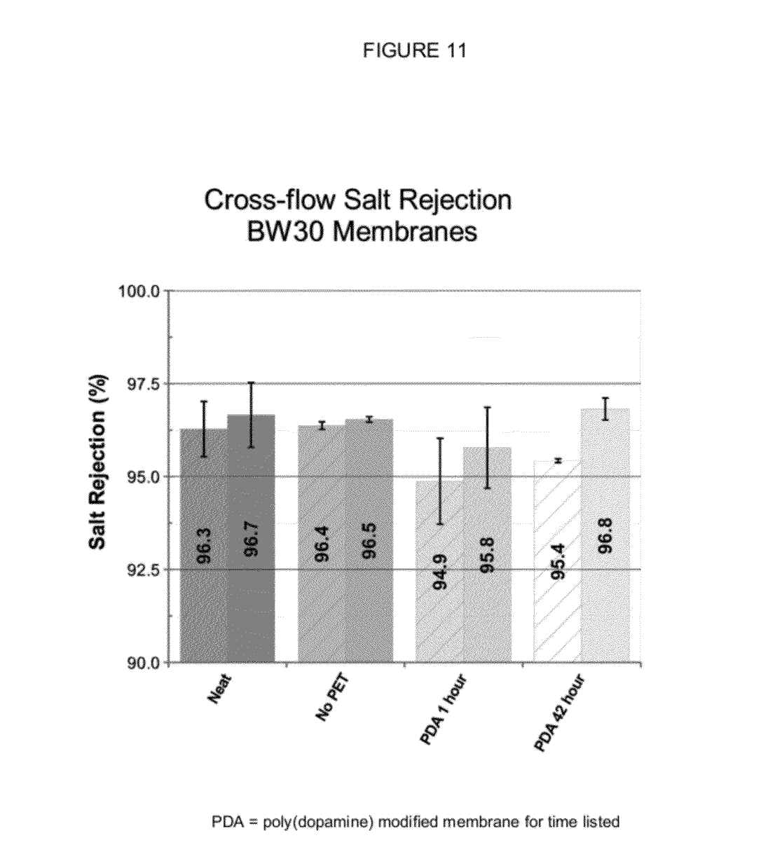

The poly(dopamine) coating procedure does not substantially alter the selectivity of the TFC membranes, as is shown in FIGS. 10 and 11.

It is understood that the examples and embodiments described herein are for illustrative purposes only. Unless clearly excluded by the context, all embodiments disclosed for one aspect of the invention can be combined with embodiments disclosed for other aspects of the invention, in any suitable combination. It will be apparent to those skilled in the art that various modifications and variations can be made to the present invention without departing from the scope of the invention. Thus, it is intended that the present invention cover the modifications and variations of this invention provided they come within the scope of the appended claims and their equivalents. All publications, patents, and patent applications cited herein are hereby incorporated herein by reference for all purposes.

What is claimed is:

1. A method of modifying a thin film composite membrane, wherein the thin film composite membrane comprises a selective layer and a support layer, the method comprising:
wetting the support layer with a wetting agent to produce a wetted layer;
rinsing the wetted layer to produce a rinsed layer; and
coating the rinsed layer with poly(dopamine).

2. A method according to claim 1, where the support layer comprises a porous polymer layer, a fabric layer, or a combination thereof.

3. A method according to claim 2, where the support layer comprises a porous polymer layer and a fabric layer.

4. A method according to claim 1, where the support layer comprises a porous polymer layer and a fabric support layer, wherein the porous polymer layer is mid-layer disposed between the selective layer and the fabric layer.

5. A method according to claim 2, further comprising removing the fabric layer prior to wetting the porous polymer layer to produce the wetted layer.

6. A method according to claim 2, wherein wetting comprises wetting the porous polymer mid-layer and a fabric support layer to produce the wetted layer.

7. A method according to claim 1, wherein the wetting agent is an alcohol or a surfactant.

8. A method according to claim 7, wherein the wetting agent is an alcohol or a surfactant.

9. A method according to claim 8, wherein the alcohol is isopropyl alcohol.

10. A method according to claim 1, wherein rinsing comprises rinsing with water to remove the wetting agent.

11. A method according to claim 10, wherein water is deionized water bath.

12. A method according to claim 11, wherein the deionized water bath is chilled.

13. A method according to claim 10, wherein rinsing with water is done at least once.

14. A method according to claim 1, further comprising storing the rinsed layer in chilled deionized water prior to coating.

15. A method according to claim 1, wherein coating the rinsed layer with poly(dopamine) comprises exposing only the rinsed layer to the poly(dopamine).

16. A method according to claim 1, wherein poly(dopamine) is obtained by mixing dopamine solution with Tris-Hydrochloride buffer solution.

17. A method according to claim 16, wherein Tris-Hydrochloride buffer solution is pH about 8.5 to about 8.7.

18. A method according to claim 1, wherein coating the rinsed layer with poly(dopamine) is done at room temperature.

19. A method according to claim 1, wherein the rinsed layer is coated with poly(dopamine) up to 48 hours.

20. A method according to claim 19, wherein the rinsed layer is coated with poly(dopamine) for about 1 hour.

21. A method according to claim 19, wherein the rinsed layer is coated with poly(dopamine) for about 24 hours.

22. A method according to claim 1 wherein the steps of wetting, rinsing and coating are conducted during manufacturing of the thin film composite membrane.

23. A method according to claim 1 wherein the steps of wetting, rinsing and coating are conducted after the step of manufacturing of the thin film composite membrane.

24. A modified thin film membrane structure comprising
a selective layer; and
a support layer comprising:
a porous polymer layer,
a fabric layer, or
a combination thereof, wherein the support layer is coated with poly(dopamine).

25. A modified thin film membrane according to claim 24, wherein the support layer comprises a combination of the porous polymer layer and the fabric layer.

26. A modified thin film membrane according to claim 25, wherein the porous polymer layer is disposed between the selective layer and the fabric layer.

27. A modified thin film membrane according to claim 24, wherein the support layer comprises the porous polymer layer only.

28. A modified thin film membrane according to claim 24, wherein the porous polymer layer is coated with poly(dopamine).

29. A modified thin film membrane according to claim 24, wherein the porous polymer layer and the fabric layer are both coated with poly(dopamine).

30. Use of a modified thin film membrane structure according to claim 24 in engineered osmosis.

31. Use according to claim 30, wherein engineered osmosis is forward osmosis, pressure retarded osmosis, direct osmotic concentration, or reverse osmosis.
